(19) United States
(12) Patent Application Publication
(10) Pub. No.: US 2006/0106822 A1
(43) Pub. Date: May 18, 2006

(54) Web-based editing system of compound documents and method thereof

(76) Inventors: Chao-Chun Lee, Taipei (TW); Chun-Nan Yu, Kaohsiung City (TW); Hao-Wei Cheng, Tao-Yuan City (TW); Wen-Hao Hsu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/989,375

(22) Filed: Nov. 17, 2004

(51) Int. Cl. G06F 7/00

(52) U.S. Cl. 707/100

(57) ABSTRACT

A web-based editing system of compound documents suitable for web browsing and the method thereof are disclosed. By using the web-based editing system, different kinds of files may be uploaded to a web folder and then transformed into several HTML files and XML-based files for viewing in a web browser (for instance, Internet Explorer). The above-mentioned different kinds of files include *.ppt (PowerPoint files), *.doc (Word files), *.xls (Excel files), .mht (packaged web files) and image files (*.bmp, *.jpg, *.gif, *.png).

### BACKGROUND OF THE INVENTION

1. Field of the Invention

The present invention generally relates to a system and method of editing web pages on-line, and more particularly to a web-based editing system of compound documents suitable for web browsing and the method thereof.

2. Description of the Prior Art

In some related prior art, a method of direct viewing the contents of document files is provided, which uses a method similar to displaying a web document. By using a web browser itself or being integrated with various applications in a computer system, the method utilizes a user to open and view the contents of several files with various file formats. In this regard, the above-mentioned file formats include not only text files (*.txt), but also *.xls (Excel files), *.mdb (Access files), *.doc (Word files), *.ppt (PowerPoint files), *.rtf (text files), *.wri (text files), *.pdf (Adobe portable document format files), *.htm (web pages), *.eml (email files), *.url (uniform resource locator), *.asp (active server pages) and general images (*.jpg, *.gif, *.bmp). Further, those files may be opened and displayed by means of a web browser calling for the corresponding applications.

However, the disadvantage of the above-mentioned method is that the contents of the document files are opened and displayed by calling for the corresponding applications, for instance, Microsoft Word, Microsoft Excel and Microsoft PowerPoint, and therefore the method requires local (client-side) installation of these software packages and is not convenient for users. In addition, the user cannot combine materials from different source formats, such as combining an Excel sheet with a PowerPoint slide into a new document for presentation. Besides, when viewing a sheet of an Excel file or opening a slide of a PowerPoint file, the method doesn't provide a paginal display function (i.e. the files are presented to the user as pages of information) that results in a time-consuming and inconvenient situation.

### SUMMARY OF THE INVENTION

According to the above-mentioned description, one of the purposes of the present invention is to provide a web-based editing system of compound documents suitable for web browsing and the method thereof. By using the web-based editing system, different kinds of files may be uploaded to a web folder and then transformed into several HTML files and XML-based files for viewing in a web browser (for instance, Internet Explorer).

Furthermore, another one of purposes of the present invention is to provide a web-based editing system with certain functions, for instance, paginally displaying, document hiding, modifying a heading of the document, adjusting the order of the document, and packaging compound document-related materials into a XML file. The user interface of the web-based editing system utilizes a way of drag and drop, thus a user may drag the document from a personal data area to a document integration area. In a word, the web-based editing system utilizes an integration of viewing, editing, file-converting, and packaging for several files with various file formats.

### BRIEF DESCRIPTION OF THE DRAWINGS

The present invention can be best understood through the following description and accompanying drawings, wherein:

FIG. 1 is a diagram illustrating the web-based editing system according to an embodiment of the present invention;

FIG. 2A and FIG. 2B are flow diagrams illustrating the web-based editing system according to embodiments of the present invention;

FIG. 3 is a diagram illustrating the menu bar of the web-based editing system according to an embodiment of the present invention;

FIG. 4 is a diagram illustrating the document-uploading function of the web-based editing system according to an embodiment of the present invention;

FIG. 5 is a diagram illustrating the document-preview function of the web-based editing system according to an embodiment of the present invention;

FIG. 6 is a diagram illustrating the document-editing function of the web-based editing system according to an embodiment of the present invention; and

FIG. 7 is a diagram illustrating the functions of an electronic white-boarding module integrated with the web-based editing system according to an embodiment of the present invention.

### DESCRIPTION OF THE PREFERRED EMBODIMENT

Some appropriate and preferred embodiments of the present invention will now be described in the following. It should be noted, however, that the embodiment is merely an example and can be variously modified without departing from the range of the present invention.

Accordingly, the present invention is to provide a web-based editing system of compound documents suitable for web browsing and the method thereof. By using the web-based editing system, different kinds of files can be uploaded to a web folder and then transformed into several HTML files and XML-based files for viewing in a web browser. The above-mentioned several files include *.ppt (PowerPoint files), *.doc (Word files), *.xls (Excel files), *.mht (single packaged web pages) and image files (*.bmp, *.jpg, *.gif and *.png).

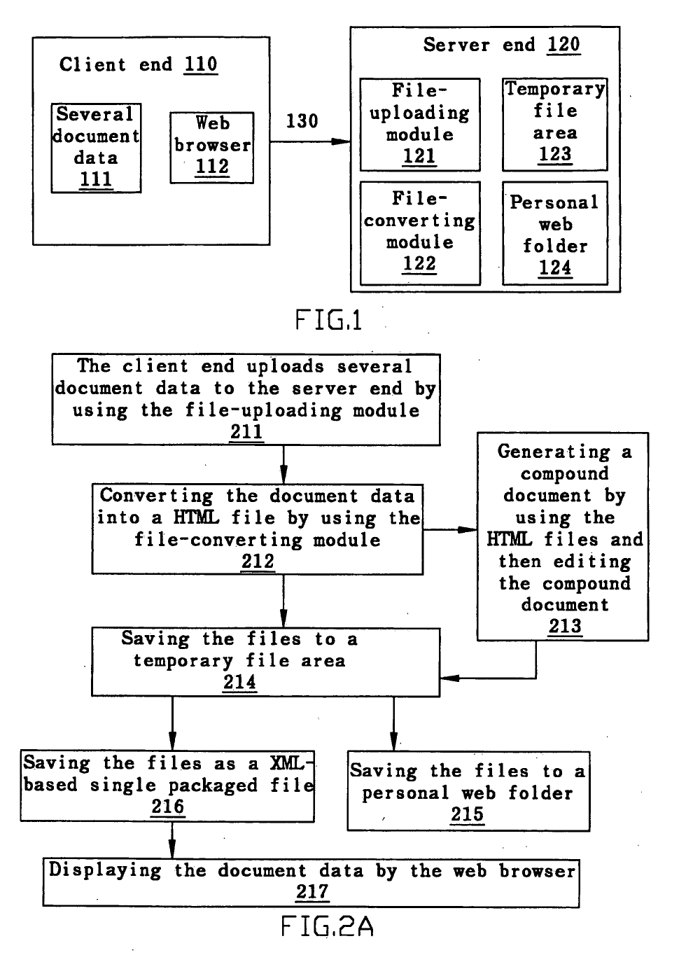

FIG. 1 is a diagram illustrating the web-based editing system according to an embodiment of the present invention, wherein 110 is a client end and 120 is a server end. The client end 110 includes several document data 111, a web browser 112, and the server end 120 includes a file-uploading module 121, a file-converting module 122, a temporary file area 123 and a personal web folder 124. The client end 110 uploads the several document data 111 to the server end 120 by using the file-uploading module 121, and the file-uploading step is performed through a wireless or a wire network connection (130) by using Request for Comments (RFC) 1867, which is “Form-based file upload in HTML”.

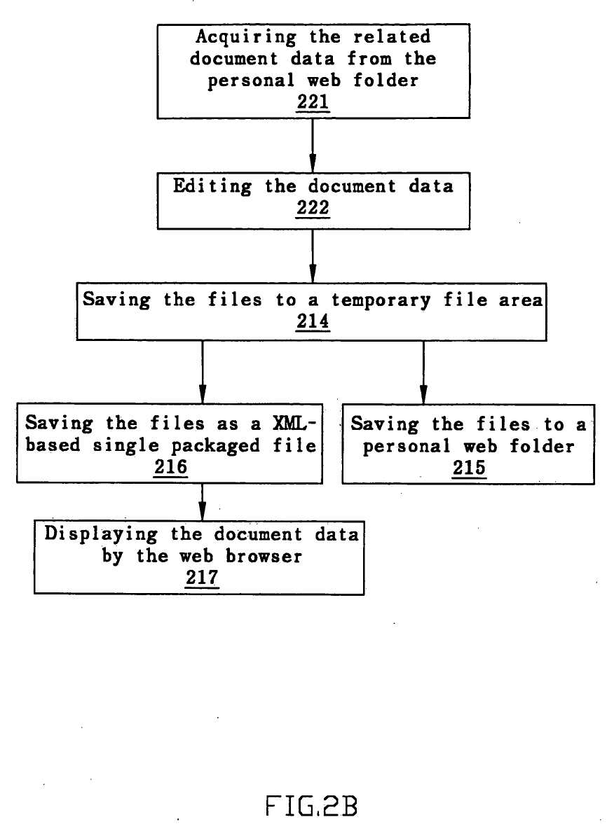

FIG. 2A and FIG. 2B are flow diagrams illustrating the web-based editing system according to embodiments of the present invention. First, the client end uploads several document data to the server end by using the file-uploading module (step 211). Next, converting the document data into a HTML file by using the file-converting module (step 212), and the file-converting module is performed by using Component Object Model (COM) of Microsoft Office (via Java Native Interface on J2EE platform). And next, saving the files to a temporary file area (step 214), and each of the file-converting steps generates a folder and corresponding HTML files, image files and other related XML file. Alternatively, saving the files to a personal web folder (step 215) or saving the files as a XML-based single packaged file (step 216). Finally, the document data may be displayed by using the web browser (step 217).

Besides, in another embodiment of the present invention, the web-based editing system utilizes a method of generating a compound document containing contents from different document sources. The above-mentioned method includes the steps in the following. First, the client end uploads several document data to the server end by using the file-uploading module (step 211). Next, converting the document data into a HTML file by using the file-converting module (step 212), and the file-converting module is performed by using Component Object Model (COM) of Microsoft Office (via Java Native Interface on J2EE platform). Then, generating a compound document by using the HTML files and then editing the compound document (step 213), for instance, a user may produce a compound document when there is a need of viewing a sheet of one Excel file or opening a slide of one PowerPoint file. And next, saving the file to a temporary file area (step 214), and alternatively, saving the files to a personal web folder (step 215) or saving the files as a XML-based single packaged file (step 216). Finally, the document data may be displayed by using the web browser (step 217).

Referring to FIG. 2B, in another embodiment of the present invention, step 221 is acquiring the related document data from the personal web folder. And then, step 222 is editing the document data and step 214 is saving them to the temporary file area. Alternatively, saving the files to a personal web folder (step 215) or saving the files as a XML-based single packaged file (step 216). Finally, the document data may be displayed by using the web browser (step 217).

An example of a practical application will be described below to depict in detail the step of converting the document data into HTML files. First, converting a PowerPoint file (*.ppt) into a HTML file. By using the COM component in the Microsoft Office, a folder and various related files, such as *.html, *.jpg, *.gif and *.xml may be generated. Then, acquiring the information of each slide of the PowerPoint file, for instance the heading of each slide. And next, saving the information and the relative URL path as an XML file. Similarly, other file formats may also be converted and then saved as the XML file. In this regard, the XML file is used to realize the whole relative URL paths and the descriptions (for instance, file name and heading) and help the web-based editing system to perform the functions, adjusting the slide order and modifying the headings.

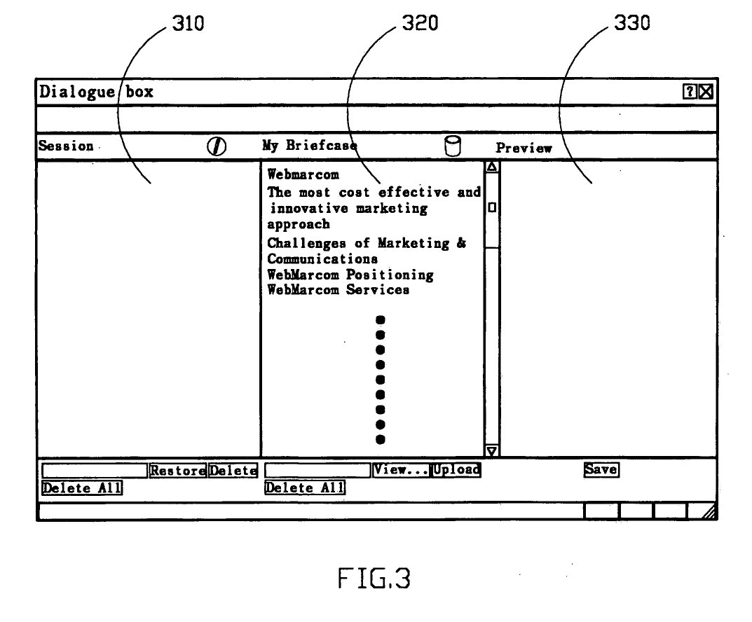

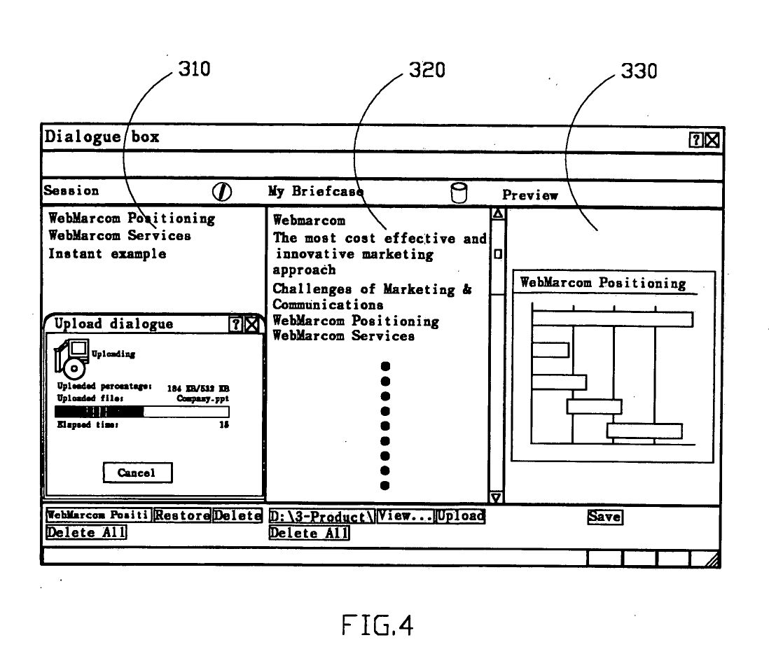

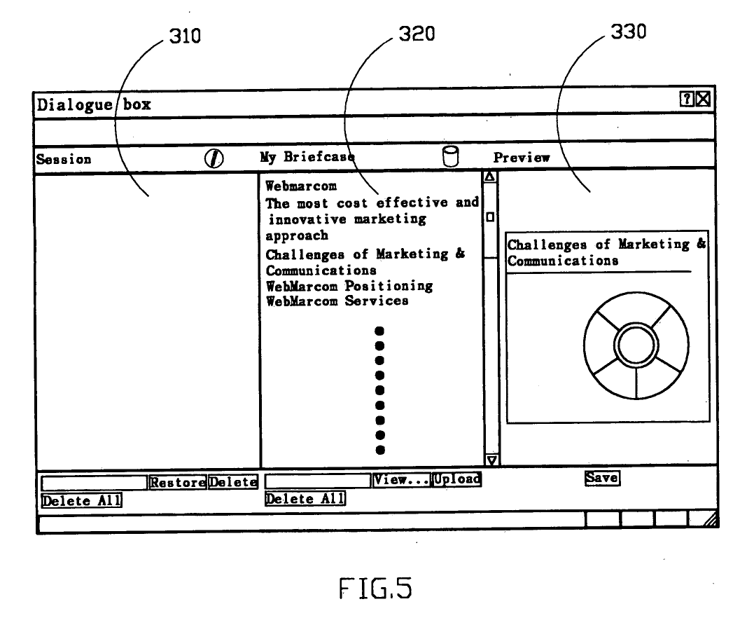

For an advanced description illustrating the above-mentioned web-based editing system, FIG. 3 is a diagram illustrating the menu bar of the web-based editing system according to an embodiment of the present invention. The user interface of the editing system includes three main areas including a document integration area 310, a personal data area 320 and a preview area 330. The document integration area 310 is configured to edit various document data, the personal data area 320 is configured to display the document data belonging to the current user, and the preview area 330 is configured to preview the contents of the document data. Next, referring to FIG. 4, it is a diagram illustrating the document-uploading function of the web-based editing system according to an embodiment of the present invention. When a file-uploading step is performed, a dialogue box (for instance, upload dialogue) may be generated by the editing system. In this regard, the file-uploading step is performed through a wireless or a wire network connection by using Request for Comments (RFC) 1867, which is “Form-based file upload in HTML”. Referring to FIG. 5, it is a diagram illustrating the document-preview function of the web-based editing system according to an embodiment of the present invention. The editing system may preview the document data by using a web browser (for instance, Internet Explorer) after the various document data is converted into a HTML file.

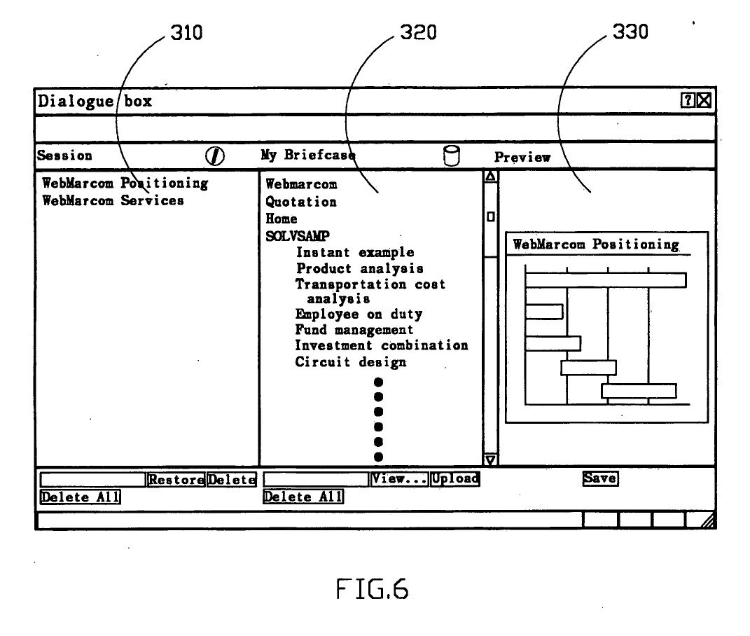

Referring to FIG. 6, it is a diagram illustrating the document-editing function of the web-based editing system according to an embodiment of the present invention. The editing system has a paginal display function of the document data by using a web browser after the various document data is converted into a HTML file. For instance, the PowerPoint file shown in FIG. 6 is divided into several slides including product analysis, transportation cost analysis, employee on duty, fund management, investment combination and circuit design. The above-mentioned document editing and paginally displaying steps are performed by the internal mechanism of the web-based editing system, which writes the names of each of the slides and the relative URL paths into a XML file for saving the descriptions of the uploaded document data. Finally, the XML file along with related materials, are compressed as a single packaged file by using a ZIP mechanism. A user may connect with the server end or download/view this zip file through the user interface of the editing system for performing the functions, such as adjusting the slide order, modifying the headings, document hiding and document preview.

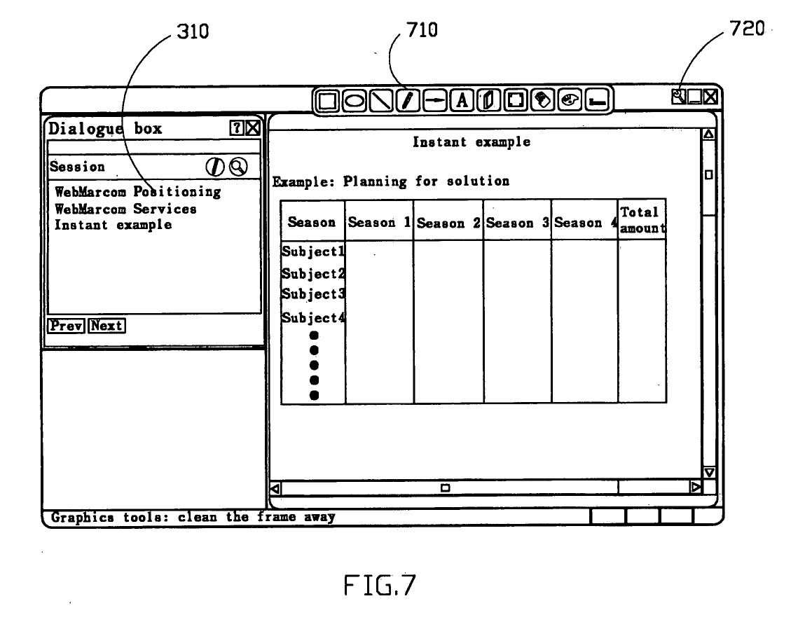

In the following, FIG. 7 is a diagram illustrating the functions of an electronic white-boarding module integrated with the web-based editing system according to an embodiment of the present invention. In this regard, the menu bar of the web-based editing system shown in FIG. 7 includes the assistant menu bar 710 and the additional menu bar 720 of the electronic white-boarding module. Accordingly, one of the advantages of converting the various document data into a HTML file is that, it may be performed an additional function by being integrated with the electronic white-boarding module. It should be appreciated that the electronic white-boarding module is not an emphasis of the present invention and it is well known by persons skilled in the art, and therefore need not be described herein.

While this invention has been described with reference to illustrative embodiments, this description does not intend or construe in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A web-based editing method of compound documents suitable for web browsing, comprising:
providing an user interface, said user interface having a personal data area, a document integration area and a preview area, wherein said personal data area is configured to display a plurality of document data of a client end, said document integration area is configured to edit said plurality of document data, and said preview area is configured to preview the contents of said plurality of document data;
transmitting said plurality of document data to a server end by using a file-uploading module, wherein said server end has a file-converting module, a temporary file area, a personal web folder and said file-uploading module;
converting each of said plurality of document data into a web document by said file-converting module, wherein said web document comprises a folder, a first markup language document, at least one image and a second markup language document; and
saving said web document to said temporary file area.

2. The web-based editing method according to claim 1, further comprising:
saving said web document to said personal web folder; and
displaying said web document on said preview area.

3. The web-based editing method according to claim 1, further comprising:
converting said web document into a single packaged file by using said file-converting module, wherein said single packaged file is a XML-based compound document;
saving said single packaged file to said personal web folder; and
displaying said single packaged file on said preview area.

4. The web-based editing method according to claim 1, wherein said plurality of document data is selected from the group consisting of *.ppt (PowerPoint files), *.doc (Word files), *.xls (Excel files), *.mht (single packaged web pages) and image files (*.bmp, *.jpg, *.gif and *.png).

5. The web-based editing method according to claim 1, wherein said first markup language document is a HyperText Markup Language (HTML) file.

6. The web-based editing method according to claim 1, wherein said second markup language document is an extensible Markup Language (XML) file.

7. The web-based editing method according to claim 2, wherein the step of displaying said web document is performed by using a web browser.

8. The web-based editing method according to claim 3, wherein the step of displaying said single packaged file is performed by using a web browser.

9. The web-based editing method according to claim 1, wherein said file-uploading module is configured to upload said plurality of document data through a wireless or a wire network connection by using Request for Comments (RFC) 1867.

10. The web-based editing method according to claim 1, wherein said file-converting module is configured to convert said plurality of document data by using Component Object Model (COM) of Microsoft Office (via Java Native Interface on J2EE platform).

11. The web-based editing method according to claim 1, further comprising performing a step of editing said web document after each of said plurality of document data is converted into said web document.

12. The web-based editing method according to claim 11, wherein the step of editing said web document comprises adjusting the order of said web document, modifying the heading of said web document, hiding said web document and paginally displaying said web document.

13. A web-based editing system of compound documents suitable for web browsing, comprising:
a client end having a plurality of document data and a web browser;
an user interface having a personal data area, a document integration area and a preview area, wherein said personal data area is configured to display a plurality of document data, said document integration area is configured to edit said plurality of document data, and said preview area is configured to preview the contents of said plurality of document data;
a server end having a file-converting module, a temporary file area, a personal web folder and a file-uploading module, wherein said file-uploading module is configured to upload said plurality of document data to said personal data area, said file-converting module is configured to convert each of said plurality of document data into a web document and said web document comprises a folder, a first markup language document, at least one image and a second markup language document.

14. The web-based editing system according to claim 13, wherein said first markup language document is a HyperText Markup Language (HTML) file.

15. The web-based editing system according to claim 13, wherein said second markup language document is an eXtensible Markup Language (XML) file.

16. The web-based editing system according to claim 13, wherein said plurality of document data is selected from the group consisting of *.ppt (PowerPoint files), *.doc (Word files), *.xls (Excel files), *.mht (single packaged web pages) and image files (*.bmp, *.jpg, *.gif and *.png).

17. The web-based editing system according to claim 13, wherein said preview area is configured to display said web document by using said web browser.

18. The web-based editing system according to claim 13, wherein said file-uploading module is configured to upload said plurality of document data through a wireless or a wire network connection by using Request for Comments (RFC) 1867.

19. The web-based editing system according to claim 13, wherein said file-converting module is configured to convert said plurality of document data by using Component Object Model (COM) of Microsoft Office (via Java Native Interface on J2EE platform).

20. The web-based editing system according to claim 13, wherein said file-converting module is configured to convert said web document into a single packaged file, and said single packaged file is a XML-based compound document.

21. The web-based editing system according to claim 20, wherein said preview area is configured to display said single packaged file by using a web browser.

22. The web-based editing system according to claim 13, wherein said integration document area is configured to edit said web document after each of said plurality of document data is converted into said web document.

23. The web-based editing system according to claim 22, wherein the function of editing said web document comprises adjusting the order of said web document, modifying the heading of said web document, hiding said web document and paginally displaying said web document.
